(19) United States
(12) Patent Application Publication
(10) Pub. No.: US 2026/0225029 A1
(43) Pub. Date: Aug. 6, 2026

(54) APPARATUS AND METHOD FOR POLLUTANT REMOVAL

(71) Applicant: Daphne Solutions SA, St-Sulpice VD (CH)

(72) Inventors: William Jamieson Ramsay, St-Sulpice VD (CH); Juan Mario Michan, St-Sulpice VD (CH); Steven Iglesias, St-Sulpice VD (CH)

(73) Assignee: Daphne Solutions SA, St-Sulpice VD (CH)

(21) Appl. No.: 19/153,052

(22) PCT Filed: Feb. 2, 2024
(86) PCT No.: PCT/EP2024/052576

§ 371 Date: Aug. 1, 2025

(30) Foreign Application Priority Data
Feb. 3, 2023 (EP) 23154987.4

(51) Int. Cl. B01D 53/14; B01D 53/18; B01D 53/76

(52) U.S. Cl. CPC B01D 53/1418; B01D 53/1493; B01D 53/18; B01D 53/76; B01D 2251/104; B01D 2252/103; B01D 2257/302; B01D 2257/404

(57) ABSTRACT

There is provided use of ammonium ions in wash water of a wet scrubber. Further, an apparatus is provided for removing pollutants from a gas. The apparatus comprises a scrubber connectable in use with a gas supply thereby allowing gas to pass into the scrubber; a wash water supply arranged in use to provide wash water to the scrubber, the wash water containing ammonium ions; and a collector arranged in use to receive wash water from the scrubber provided by the wash water supply. A method of removing pollutants from a gas is also provided.

### FIELD OF THE INVENTION

The present disclosure relates to removal of pollutants, such as sulphur oxides (SOx) and/or nitrogen oxides (NOx), from a gas using chemical reactions and separation. The gas is intended to be a polluted gas, such as an exhaust gas, for example, from an industrial engine, such as those, running on a fuel that contains sulphur and/or involving nitrogen in their combustion.

### BACKGROUND

Exhaust emissions from combustion fuels with sulphur content, i.e. sulphur-based fuels, mainly comprise nitrogen, oxygen, carbon dioxide (CO2, CO₂) and water vapour, plus smaller quantities of NOx, SOx, carbon monoxide (CO), various hydrocarbons at different states of combustion and complex particulate matter (PM). SOx are produced during combustion of fossil fuels that contain sulphur, whereby the quantity of SOx in fuel exhausts vary according to natural differences in the sulphur content of fuels. NOx are also produced during combustion of fuels and oxidation in the fuel that contains already ionized nitrogen, such as coal. The amount of NOx in fuel exhausts vary depending on the conditions of the combustion and oxidation in the fuel.

The dominant constituent, making up more than 95% of the SOx emission from combustion of fossil fuels, is sulphur dioxide (SO2, SO₂). This is a toxic gas, directly harmful for both fauna and flora, and, when present in the atmosphere, leads to acid rain.

NOx includes nitrogen oxide (NO) and nitrogen dioxide (NO2, NO₂) that has a negative effect on human health, vegetation, and ecosystems.

Combustion is widely used to convert chemical energy into heat or thermal energy. An important application is internal combustion engines, where the heat from combustion is used to obtain mechanical energy. Such systems are commonly used in transport application and industrial applications for generating electricity or having a source of electrical and thermal power. A significant fraction of the propulsion of the global shipping fleet is provided by such industrial engines. These industrial engines are adapted for use aboard ships and are called marine engines.

In response to harmful impacts of pollutants the International Maritime Organization (IMO), through its Marine Environment Protection Committee (MEPC), introduced regulations for the prevention of air pollution under Annex VI of the International Convention for the Prevention of Pollution from Ships (MARPOL) Convention. This imposes a framework of mandatory limits on emissions of SOx and NOx.

To meet reduced SOx emission limits, low-sulphur residual and distillate fuels, and, in the longer term, alternatives can be used. However, there is limited availability of natural low-sulphur fuels and the refinery process for desulphurisation is costly and energy demanding.

If using sulphur-based fuels, alternatives to low-sulphur fuels are Exhaust Gas Treatment Systems (EGTS) known as SOx scrubbers. These clean exhaust gas to reduce SOx emissions to a level equivalent to the required fuel sulphur content. This offers flexibility to operate on low-sulphur fuels or to use higher sulphur fuels in combination with a SOx scrubber.

Two main types of SOx scrubbers exist. These are wet scrubbers, which use water (using either seawater or fresh) as the scrubbing medium, commonly referred to as “wash water”; and dry scrubbers, which use a dry chemical as a scrubbing medium. Wet scrubbers are further divided into open loop systems (that use seawater) and closed loop systems (that use fresh water with the addition of an alkaline chemical). Hybrid systems, which can operate in both open loop and closed loop modes, also exist. For wet scrubbers, the term “scrubbing” is typically intended to mean “absorbing”, meaning that SO2 is absorbed by the aqueous solution.

When using a wet open loop SOx scrubber, the main disadvantage is that the discharge water is extremely damaging and toxic to aquatic life. Open loop wet SOx scrubbers have, therefore, been banned in several countries and regions.

To address this, closed loop SOx scrubbers can be used.

Alkaline chemicals used in closed loop wet scrubbers include caustic soda (NaOH), which is the most commonly used, lime (Ca(OH)2, Ca(OH)₂) and magnesium hydroxide (Mg(OH)2, Mg(OH)₂). The scrubbing process results in a neutralisation reaction between the alkaline chemicals and SOx. This produces, for example, sodium sulphate (Na2SO4, Na₂SO₄), gypsum (CaSO4, CaSO₄) and Epsom salt (MgSO4, MgSO₄), respectively. As a result, closed loop SOx scrubbers produce quantities of wash water saturated with neutralised product. The saturated wash water must be removed, and the scrubbing medium replenished to continue to remove SOx from exhaust gas. If uncontrolled, the formation of sulphate crystals leads to progressive degradation of the wash water system.

Residue removed from SOx scrubber wash water is a waste product that must, when used on a ship, be stored on board, landed ashore and disposed of appropriately. This means that, while fuels with sulphur are typically advantageous from an economic perspective, EGTS able to convert SOx still produce waste that is toxic or requires disposal.

There is therefore a need for an adaptable (SOx) scrubbing mechanism with limited, yet easily storable and transportable, by-products that are safe to handle with the mechanism also being capable of functioning effectively when receiving gas at flow rates producible by an engine.

### SUMMARY OF INVENTION

According to a first aspect, there is provided an apparatus for (i.e. suitable for) removing pollutants from a gas, comprising: a scrubber connectable in use with a gas supply thereby allowing gas to pass into the scrubber; a wash water supply arranged in use to provide wash water to the scrubber, the wash water containing ammonium ions; and a collector arranged in use to receive wash water from the scrubber provided by the wash water supply.

The wash water is understood to contain ammonium ions (NH4+, NH₄⁺). It will be further understood from this that the wash water can contain an ammonium salt ([NH4⁺][X⁻], where X⁻ is OH⁻ or another anion, such as Cl⁻) solution. This may be considered an ammonia solution, or aqueous solution of ammonia, which is a solution formed from (dissolved) ammonia and water.

By using this apparatus, from the use of ammonium ions in the wash water as a reagent, a substance, ammonium sulphate ((NH4)2SO4, (NH₄)₂SO₄), is produced. Instead of being toxic or a waste product requiring disposal, this is a useful by-product. This is because it is usable as, or as a constituent of, fertiliser. While it may be considered that high concentrations of ammonium ions would be needed to allow the apparatus to function in a viable form, due to the ammonium ions being a reagent in the liquid phase, the reactions are able to take place in the liquid phase. This allows lower concentrations of ammonium ions to be used keeping the concentrations within a safe handling range. In other words, the apparatus is able to perform pollutant conversion into valuable by-product in an aqueous environment, which provides system optimization. Further, we have found the conversion technique from pollutants to valuable by-products is possible using non-hazardous chemicals.

As such, overall, using an apparatus according to the first aspect provides an ability to remove pollutant from a gas and produce a useful by-product while using a reagent at concentrations that is safe to handle. This can be applied as an exhaust cleaning system that does not produce waste. Thus, it is suitable for a wide range of applications, from marine to land-based applications.

The wash water supply, scrubber and collector arrangement may be arranged in use to pass the wash water through the scrubber (only) once. This can use all ammonium ions in the wash water in some circumstances to remove a corresponding amount of pollutant from the gas by reaction with the ammonium ions. However, we have found this is typically not the case. As such, the collector may be connected to the wash water supply and may be arranged in use to provide received wash water to the wash water supply thereby circulating the wash water in use. This circulation of the wash water allows ammonium ions to react with constituents of the gas while it is still present as a reagent in the wash water. This makes efficient use of the ammonium ions allowing the concentration to be kept to a minimum while still removing the maximum possible quantity of pollutant(s) from the gas.

The scrubber, wash water supply and collector may provide an open-loop or hybrid scrubber (system). Typically, the scrubber, wash water supply and collector provide a closed-loop scrubber (system). This keeps the apparatus self-contained, minimising pollution, by the apparatus, of the environment around the apparatus and limits the need to raw material inputs.

The wash water may be circulated continuously or may be stopped and/or started based on one or more (predetermined) criteria, such as circulation time or volume of gas passing or passed through the scrubber. Typically however, the apparatus may further comprise a monitoring module arranged in use to analyse the wash water received by the collector and to control the circulation of the wash water based on the analysis. This allows more tailored control of the circulation and bases that circulation on the condition of the wash water within the system instead of on external or predetermined criteria that may not represent the circumstances every time the apparatus is used. Being able to tailor control of the circulation allows the apparatus to be operated in an optimal manner each time it is used.

The monitoring module may include a pH sensor arranged in use to measure the pH of the wash water received by the collector, the circulation of the wash water being based on the measured pH of the received wash water. We have found that monitoring the pH provides a simple mechanism to identify when all, or a proportion, of the ammonium ions in the wash water available as a reagent has been used to allow for circulation to be modified, stopped or paused once the amount of ammonium ions reduces to a threshold level.

Typically, an initial pH of the wash water may be up to about pH 14. By “initial” we intend to mean when the wash water is first provided to the apparatus, such as to the wash water system, whether this be for the first run of an apparatus or to replenish or top up wash water.

When the amount of ammonia solution available as a reagent is reduced to a threshold at which it is no longer worth continuing circulation, the pH of the wash water is typically about pH 6, but could be pH 7, 8 or 10. The threshold may be 0% remaining ammonium ions available as a reagent, but could be up to about 3%, up to about 5%, or up to about 17%.

The amount of remaining ammonium ions corresponds to how complete the reaction is, i.e. how much SOx remains to be reacted with or remains to be neutralised. The highest industrial standards applied for removal of SOx require 97% completion. In marine implementations 83% completion is most common and for land-based implements, typically, 95% completion is applied. The amount of completion needed does typically depend on the amount quantity of the starting amount of substance to be neutralised, however. As such, if the starting amount is very small, then standards for completion may be very close to 100% and may be stipulated to one or more decimal places.

The monitoring module may additionally or alternatively include a continuous emission monitoring system (CEMS). This, or another sensor or monitoring device or module may be arranged in use to measure properties upstream and/or downstream of the apparatus, such as by being connected to upstream and/or downstream elements, including the gas supply. The measured properties may be gas content, constituents, constituent quantities or concentration, or gas temperature, mass, volume or flow rate. This may allow tailoring of certain aspects of the pollutant removal process to account for gas properties.

When the gas is provided from an engine or similar source, the gas is likely hotter than the wash water. Should the gas be hotter than the wash water, the wash water will cool the gas and the gas will heat the wash water. The wash water can be left at the raised temperature and/or allowed to cool naturally. However, we have found that the reactions between the ammonium ions and constituents of the gas are more favourable at temperatures lower than the temperature at which, for example, exhaust gas, arriving at the apparatus according to the first aspect would be. As such, typically, cooling is appliable/applicable in use (i.e., typically, the apparatus is arranged in use to apply cooling) to the wash water between receiving the wash water from the scrubber and providing the wash water to the scrubber. This reduces the temperature of the wash water each cycle, improving the reaction efficiency allowing greater quantities of pollutant(s) to be removed from the gas.

The cooling may be applied by any suitable means. This may be achieved in use by applying heat extraction, temperature reduction, evaporative cooling, thermoelectric cooling, radiative cooling, conductive cooling and/or convective cooling. Example means of applying cooling may be applied by passage through a refrigerator or mechanical refrigerator, application or introduction of coolant, use of a heat pipe or heat sink, or using some other form of cooling device. Typically, the apparatus may further comprise a heat exchanger connected to a cooling source, the heat exchanger being arranged in use to cool the received wash water by transferring heat to the cooling source and to provide the cooled wash water to the wash water supply. This provides a simple cooling mechanism, which when an indirect heat exchanger is provided, allows cooling while keeping the chances of interaction between the cooling source and the wash water to a minimum. The heat exchanger may be a parallel flow, crossflow, spiral flow, distributed vapour or counter-current heat exchanger. Additionally or alternatively, the heat exchanger may be a double-pipe, shell and tube, plate, plate and shell, plate fin, adiabatic wheel, finned tube, pillow plate, waste heat recovery unit, (dynamic) scraped surface heat exchanger, phase-change, direct contact, microchannel, moving bed, jacketed vessel, packed bed or packed column, run-around coil, regenerator or condenser and boiler heat exchanger.

The cooling source may be a liquid. We have found that cooling is provided in a more efficient manner if the cooling source and the wash water are in the liquid phase. As such, providing the cooling source as a liquid allows for efficient cooling.

The concentration of the ammonia solution could be up to 30 to 60 percent by weight (wt % ammonia basis) or higher, such as up to 90%. The concentration of ammonia solution may be up to 25 to 30 wt %. This would provide a balance between higher concentrations, which reduce the storage space of the source of the ammonia solution or ammonia, and user safety. However, typically the ammonia solution (available, initially, as a reagent) in the wash water has a concentration up to 10 wt % (such as greater than 0 wt % and up to and including 10 wt %). We have found this provides the ability to lower quantity of pollutant(s) in a gas to a desirable level while making the wash water considerably safer to handle. This is because, at this level, such as between 5 and 10 wt %, this is comparable to the strength of household cleaning products. As such, due to the greater safety provided to users, concentrations at these levels are subject to less regulation, making it simpler to use, store and transfer. Typically, the apparatus may further comprise the wash water.

The collector may pass the received wash water out of the apparatus or, as set out above, may be connected with the wash water supply and the wash water may be circulated around the wash water supply, scrubber and collector. If passed away from the wash water supply, the wash water will need to be located somewhere since it is unlikely to be able to be emitted or discharged. If the wash water is circulated, more ammonia solution may be added as a reagent to replace ammonium ions that have reacted with one or more constituents of the gas passing through the scrubber and the reacted ammonium ions are retained in the wash water. Instead of retaining the wash water with reacted ammonium ions, typically the apparatus may further comprise a storage tank, wash water being transferable in use from the collector to the storage tank, the storage tank being arranged in use to hold wash water received by the collector. This allows used wash water, such as wash water that has little or no ammonium ions left that are able to be reacted with pollutant(s), to be held separately from the scrubber and wash water supply. Further, holding this wash water in the storage tank allows further processing or use of the wash water, such as to use the wash water or one or more constituents thereof as fertiliser or a fertiliser component.

The storage tank also allows the apparatus to provide a closed-loop. Typically, this allows the apparatus, such as the scrubber, wash water system, collector and storage tank, to be a closed-loop wet scrubber.

The amount of ammonium ions in the wash water system (such as in wash water) may be set by the initial amount of ammonium ions included in the wash water and may be left unmodified. This would cause the amount of ammonium ions available as a reagent in the wash water to reduce as the wash water is passed through the scrubber due to the ammonium ions reacting with constituents of the gas in the scrubber. Typically, the amount of ammonium ions in the wash water system is increasable in use. This allows the ammonium ions available as a reagent to be replenished. When the wash water is circulated, this allows topping up ammonium ions in the wash water. When a storage tank is provided, this may be achieved by providing further wash water after the (previous) wash water is transferred to the storage tank. This would re-set the ammonium ions amount to the concentration of ammonium ions in the newly provided wash water.

As set out above, a set amount of ammonium ions in the wash water system may be provided that may then be replenished at a later point. This is instead of continuously supplying ammonia or a form of ammonia to the system. This allows for more efficient use of ammonium ions, reducing overall use of the sources of ammonium ions while achieving a desired reduction in pollutants. Further it removes the need for an ability to continuously supply ammonia or ammonium, which may not be possible in all locations where the apparatus according to the first aspect is installed.

The apparatus may (only) provide ammonium ions to react with constituents of the gas using the wash water. However, the apparatus may further comprise an ammonia (NH3, NH₃) input, such as an ammonia source input or an input and/or inlet line at which ammonia is arranged to be provided in use or that is suitable to provide ammonia into the apparatus at, in the wash water system, and/or in the gas supply and/or scrubber, and/or in the collector. When provided to the wash water system, the ammonia dissolves in the wash water increasing the ammonium ion concentration, allowing removal of greater quantities of pollutant(s) in the gas.

When provided to the gas supply and/or scrubber, the ammonia reacts with pollutant(s) in the gas allowing the wash water to be used for longer before the ammonium ions included in the wash water as a reagent is reduced too far to continue to react. When provided to the collector, the ammonia dissolves into the wash water and reacts with pollutant(s) dissolved in the received wash water lowering the quantity of pollutant(s) in the wash water. Additionally, when ammonia (gas) is provided to the gas supply, (useful) sulphur-based by-product, produced due to reaction of the ozone with constituents in the gas, is created, which is then able to be dissolved in the wash water in the scrubber and collected.

Typically, the ammonia is provided as a gas, but may be in, or provided in, other forms.

Independently or in combination with reduction of SOx emissions, known exhaust gas cleaning techniques are required to reduce the NOx content in exhaust gas to the applicable standard(s). Selective Catalytic Reduction (SCR) systems are known to reduce NOx content in exhaust gas. An SCR can use an ammonia reagent to react with NOx over a catalyst to break down NOx into nitrogen and oxygen. The reagent is typically urea, which must be decomposed to ammonia.

Alternative reagents can also be ammonium hydroxide or anhydrous ammonia.

The use of urea is preferrable as it is less hazardous and has less safety requirements in comparison to ammonium hydroxide or anhydrous ammonia.

However, the conversion of urea to ammonia requires high temperatures in an exhaust stream. Other limitations of SCR are space requirements, capital and operational cost, emissions of other pollutants (such as, ammonia slip), formation of substances that can destroy the catalysts and additional back pressure into the exhaust stream.

In addition to the need in industry for a SOx scrubbing mechanism, there is a need in industry for an adaptable (NOx) scrubbing mechanism with limited, yet easily storable and transportable, by-products that are safe to handle with the mechanism also being capable of functioning effectively when receiving gas at flow rates producible by an engine.

The apparatus may further comprise an ozone input in the gas supply and/or scrubber. This allows NOx to be removed from the gas as well as other constituents of the gas, reducing how harmful the gas is. Further, this allows useful sulphur and nitrogen-based end-products/by-products to be produced at the same time, instead of at different stages, which reduces processing distance required to achieve this. Additionally, when ozone is provided to the gas supply, nitrogen-based by-product, produced due to reaction of the ozone with constituents in the gas, is created, which is then able to be dissolved in the wash water in the scrubber and collected. The ozone input may be an ozone source input or an input and/or inlet line at which ozone is arranged to be provided in use or that is suitable to provide ozone into the gas supply and/or scrubber.

The scrubber may have an inlet for the gas supply and an outlet for the gas supply, the inlet being lower on the scrubber than the outlet. This may form a type of vertical scrubber with gas being provided proximal to a base of the scrubber and exiting the scrubber proximal to an opposite end of the scrubber to the base. The wash water supply may provide wash water to the scrubber proximal to the outlet and the collector may receive the wash water distal to the outlet. This allows the wash water to fall under gravity, avoiding the need to pump the wash water when in the scrubber, and maximising the amount of contact between the wash water and gas. This latter point may be achieved by any opposing flow arrangement of gas and wash water able to be applied in the scrubber.

The scrubber may include an atomiser at which the wash water is provided. This causes an improvement in the ability of the wash water to absorb gas and causes constituents of the absorbed gas to react with the ammonium ions in the aqueous phase. This allows for increased reaction rates, increasing the rate of removal of pollutant(s) from the gas.

Known processes for removing pollutants from a gas supply may require multiple reagents or may require reagents added at different stages of the process. Further those reagents may be specific types, such as oxidation reagents. We have found that by using an apparatus according to an aspect, such as the first aspect, described herein, only ammonium ions or only ammonium ions and ozone may be provided as reagents and/or to capture pollutants while still allowing scrubbing of gas to reduce the pollutants by a satisfactory amount. Additionally or alternatively, the reagent or reagents (such as ammonium ions only or ammonium ions and ozone only) may only be provided upstream of a scrubber while still providing suitable reductions in pollutant in the gas being scrubbed.

According to a second aspect, there is provided a closed-loop wet scrubber including a cyclical wash water system with wash water including, in use, ammonia solution, and a storage tank in which used wash water is able to be held after cycling through the wash water system. This provides the same advantages as an apparatus according to the first aspect.

There are two main forms of scrubber. These are open-loop scrubbers and closed-loop scrubbers. A further form of scrubber also exists, which is a hybrid scrubber.

In open-loop scrubbers an external or environmental water source is used to supply wash water to a scrubber and the water is then typically passed back to the source or into the environment. This means that fresh or new water is continually used as the wash water for an open-loop scrubber.

Closed-loop scrubbers typically have a local/internal or self-contained (such as pre-provided) source for wash water. In use this is typically passed through the scrubber and returned to the source or is stored in some way so that it can be re-used in the scrubber, potentially after treatment. This allows circulation of the wash water through any system or apparatus of which the closed-loop scrubber is a component or that is provided by the closed-loop scrubber. This circulation occurs between the scrubber and any source/storage for or of the wash water.

Hybrid scrubbers are able to use either an external or local/internal source for the wash water. Hybrid scrubbers may switch between sources and wash water discharge or storage as required or may use a combination of both forms of intake and/or discharge from the scrubber simultaneously.

It is intended that a cyclical wash water system is a system that typically circulates or transfers water between (or around a loop that includes) a scrubber and a wash water source, collector and/or storage. The cycling of the wash water may be provided by any suitable form of mechanism that allows wash water to be move, such as a pump.

According to a third aspect, there is provided a method of removing pollutants from a gas, comprising: providing, to a scrubber connected to a gas supply, wash water containing ammonium ions to scrub gas from the gas supply with the wash water; and receiving, in a collector, the wash water (typically wash water containing pollutant) from the scrubber after providing the wash water to the scrubber.

According to a fourth aspect, there is provided use of ammonium ions in wash water of a wet scrubber. The use of ammonium ions in wash water of a wet scrubber may react with SOx in gas passing through the wet scrubber to produce ammonium sulphate, and/or may be use of ammonium ions in wash water of a wet scrubber and ozone in the wet scrubber to react with NOx in gas passing through the wet scrubber to produce ammonium nitrate (NH4NO3, NH₄NO₃).

According to a fifth aspect, there is provided a method of removing pollutants from a gas, comprising: providing, to a gas supply, ammonia (gas) and/or ozone; providing the gas supply to which the ammonia and/or ozone has been provided to a scrubber connected to the gas supply; providing wash water, in the scrubber, to scrub gas from the gas supply with the wash water; and receiving, in a collector, the wash water from the scrubber. This method may be a further implementation of the third aspect, with the wash water therefore containing ammonium ions.

Regardless of whether the fifth aspect is implemented with or without the features of the third aspect, this allows ammonia and/or ozone by-products (such as sulphur and/or nitrogen based by-products respectively) to be formed in the gas supply between where the ammonia and/or ozone is provided to the gas supply and where the gas supply enters the scrubber or encounters the wash water.

These by-products then pass into the wash water and are received at the collector.

### BRIEF DESCRIPTION OF DRAWINGS

Example apparatus and methods are described in detail below in relation to the drawings, in which:

FIG. 1 shows a schematic view of a first example apparatus;

FIG. 2 shows a schematic view of a second example apparatus;

FIG. 3 shows a block diagram view of the first example apparatus;

FIG. 4 shows a block diagram view of the second example apparatus;

FIG. 5 shows a block diagram view of a third example apparatus; and

FIG. 6 shows a block diagram view of a fourth example apparatus.

### DETAILED DESCRIPTION

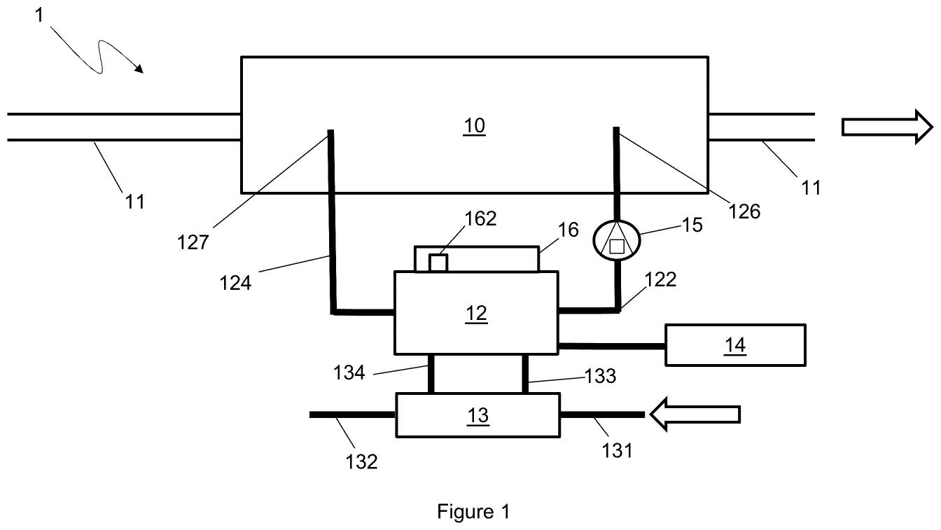

Generally illustrated at 1 in FIG. 1, there is an example apparatus suitable for removing pollutant(s) from gas. Pollutant is removable by use of a scrubber 10.

The scrubber 10 is connected to a gas supply 11. In some examples, the gas supply is an exhaust stream, such as from an industrial engine like a ships engines. This means that, in such examples, the apparatus is an EGTS. In other examples, the gas supply is from an alternative source, which could include an industrial plant gas stream.

The gas supply 11 is connected at an inlet and an outlet of the scrubber 10. In some examples, the inlet is located lower on the scrubber than the outlet. This causes the gas to flow upward when passing through the scrubber.

In various examples the inlet from the gas supply 11 to the scrubber 10 being located lower on the scrubber than an outlet to the gas supply is implemented by the scrubber being vertically orientated. This may be in the form of a column with the inlet at or near the base and the outlet at or near the opposing top end of the scrubber.

The scrubber 10 is intended to be a wet scrubber. As such, a wash water supply 12 is provided. This is connected to the scrubber and is capable of supplying wash water to the scrubber. This is typically achieved by a supply or inlet pipe 122 or conduit being provided between the wash water supply and the scrubber.

The wash water supply 12 is able to take the form of a tank in some examples. In other examples an alternative implementation of the wash water supply is provided.

The wash water supply 12 is able to pass wash water to the scrubber 10 in use. The wash water is then able to be returned to the wash water supply by a collection pipe 124 or conduit. In some examples, this also makes the wash water supply a collector.

The scrubber 10 can be any form of scrubber. Typically, this means the scrubber has at least one chamber (not shown) and that wash water is provided to each chamber by the inlet pipe 122. The wash water is sprayed into the chamber, and, in some examples, the spray mechanism is an atomiser 126, such as at an output section of the inlet pipe. The wash water is able to be removed from the scrubber by use of some form of drain 127 or outflow. This would pass to the collection pipe 124 in various examples.

In a vertically orientated scrubber, in some examples the inlet pipe 122 provides the wash water above the inlet. Additionally, the wash water is typically allowed or directed to flow in the opposite direction to the gas being provided by the gas supply 11. The drain 127 to the collection pipe 124 is then provided lower than where the inlet pipe provides the wash water.

This counter flow of wash water and gas supply aids cooling in some circumstances, such as in a vertically orientated scrubber. In horizontally orientated scrubbers, there may be a parallel flow of wash water and gas supply, such as by providing the wash water at or close to the same end of the scrubber at which the gas supply is provided and providing a drain at or close to the same end of the scrubber as the gas supply leaves the scrubber. As such, in various examples, the gas supply and wash water are able to flow in opposite directions to each other or in the same direction when in the scrubber.

When the gas provided to the scrubber by the gas supply 11 is hotter than the wash water, the gas temperature will be lowered and the wash water temperature will be raised. In the example shown in FIG. 1, the wash water supply 12 is connected to a heat exchanger 13. This allows wash water in the wash water supply is able to be cooled using the heat exchanger.

The heat exchanger 13 in some examples, such as the example shown in FIG. 1, is a plate heat exchanger. This may be any form of plate heat exchanger, such as known heat exchangers. In view of this, the heat exchanger typically functions and operates in a known manner. In other examples, the heat exchanger is able to be another form of heat exchanger and able to be located at other locations as appropriate for providing cooling.

In the example shown in FIG. 1, the heat exchanger 13 is connected to an external cooling source (not shown). This provides coolant at a coolant inlet 131, which passes through the heat exchanger to provide cooling and leaves by a coolant outlet 132. Wash water is provided from the wash water supply 12 to the heat exchanger through a wash water inlet 133, and once cooled, returns to the wash water supply from the heat exchanger via a wash water outlet 134.

In examples where the apparatus is provided on a ship, the heat exchanger 13 is typically connected to a ship cooling system, such as a central cooling system. In various examples when the apparatus is provided on a ship, the coolant is sea water.

The wash water supply 12 is connected to a storage tank 14. In FIG. 1, this is shown as a separate tank to the wash water supply, but, in some examples, may be provided integral with the wash water supply. At minimum, the storage tank provides a means of segregating at least a portion of the wash water from the (rest of) the wash water supply.

In various examples, transfer of wash water between the wash water supply 12 and the storage tank 14 is controlled by some form or flow control (not shown), such as a tap, valve or flow regulator. This able to be provided by a known mechanism.

To provide the wash water to the scrubber 10, in some examples, a pump 15 is provided. In FIG. 1 this is shown as being provided on inlet pipe 122. In various examples, the pump is a positive displacement pump. Regardless of this, the pump can be provided by any suitable form of pump capable of providing an adequate flow rate and pressure of wash water, such as known pumps.

In some examples, the apparatus 1 has a monitoring module 16. In FIG. 1 this is shown as being connected to the wash water supply 12. In other examples, this is able to be located anywhere on the apparatus where it is possible to monitor the wash water.

The monitoring module 16 includes, in various examples, a pH sensor 162. This is able to measure the pH of the wash water. Typically, this measures the pH of the wash water in the wash water supply 12, but in several examples is able to measure the pH of the wash water in other locations additionally or as an alternative. The pH sensor is typically provided by a sensor that is capable of measuring the pH of a liquid, and may be a known pH sensor.

The monitoring module 16 is typically arranged in use to control circulation of wash water through the wash water supply 12, inlet pipe 122, pump 15, atomiser 126, scrubber 10, drain 127, collection pipe 124, storage tank 14 and/or heat exchanger 13. This control is able to be based on the pH measured by the pH sensor 162 and/or on other measurements, such as temperature, viscosity and/or turbidity.

This control may be achieved by adjusting operation of the pump, but can be achieved through other means.

In use, the wash water includes ammonium ions. This is typically provided with water and is present in the form of ammonium hydroxide when the wash water supply is initially filled. Further detail is provided below as to the use of the ammonium ions and the response of the apparatus 1 to that use.

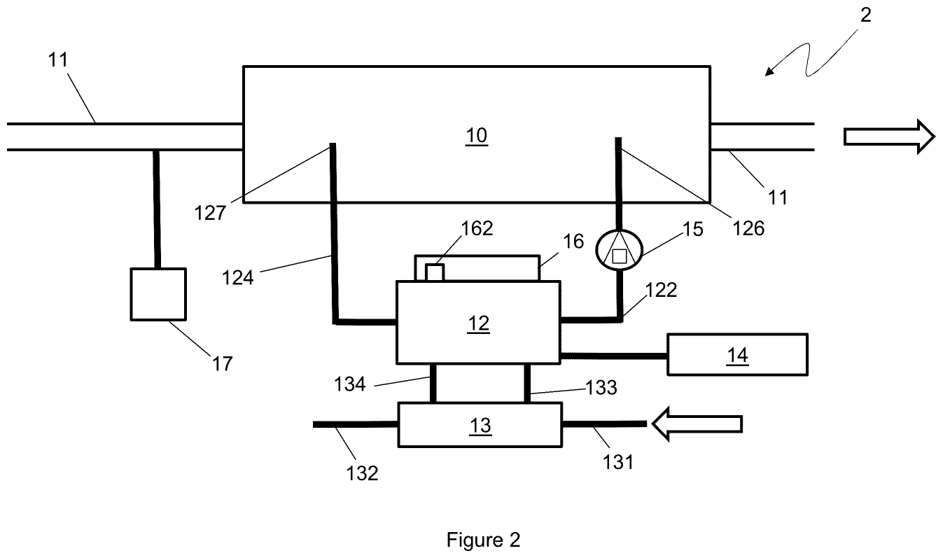

FIG. 2 shows a second example apparatus 2. This has features that are identical to features of the first example apparatus 1 shown in FIG. 1, and as such, has a scrubber 10, gas supply 11, wash water supply 12, inlet pipe 122, collection pipe 124, atomiser 126, drain 127, heat exchanger 13, coolant inlet 131, coolant outlet 132, wash water inlet 133, wash water outlet 134, storage tank 14, pump 15, monitoring module 16 and pH sensor 162 as described above. Features that are common to the first example apparatus and the second example apparatus are identical to each other, operate in the same way and have the same functions.

In addition to these features, the example apparatus 2 shown in FIG. 2 has an ozone injector 17. This is arranged in use to provide ozone to the gas supply 11 in the example shown. The ozone is provided from an ozone source. In other examples, the ozone injector 17 is provided directly to the scrubber. Further detail is provided below as to the use of the ozone and the response of the apparatus to that use.

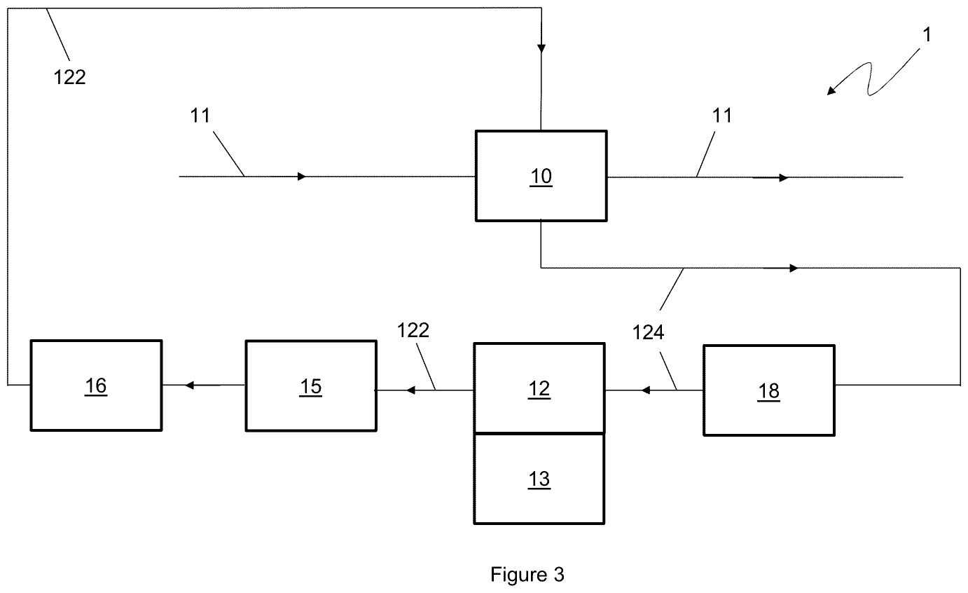

Turning to the functionality of example apparatus, FIGS. 3 to 6 show block diagrams by which the functionality of example apparatuses are described.

Ammonia can be injected directly into the gas supply 11 before it reaches the scrubber 10. This can be optimized in terms of space, however. FIG. 3 shows an apparatus 1 according to the first example that can be used to achieve this.

This example apparatus has a scrubber 10. This is connected to a wash water supply 12 by an inlet pipe 122 and collection pipe 124.

In the example shown in FIG. 3 the inlet pipe 122 can be seen to have a pump 15 and monitoring module 16 connected along its length. In this example, the implementation of the monitoring module shown is as a control device used to control flow of wash water in the apparatus 1.

In addition to the pump 15 and the monitoring module 16, the example shown in FIG. 3 has a collection pump 18 (which is optional). This is provided along the collection pipe 124, and, when provided, assists, in use, with drawing wash water from the scrubber 10.

From a fluid point of view, the general process that is followed is that a gas stream is provided from the gas supply 11 to the scrubber 10. The gas stream contains SOx, and to remove SOx from the gas stream, a cleaning cycle is carried out.

This involves the gas stream entering the scrubber; and SOx in the gas stream being trapped in the aqueous solution the wash water provides. The wash water, and therefore the aqueous solution, has a variable composition during the cleaning cycle.

At a first step of the cleaning cycle, when the wash water supply 12 is empty it is refilled with wash water of ammonium hydroxide at an appropriate concentration.

This concentration is set by the concentration of SOx in the gas stream that is expected to be treated since the ammonia solution is provided as a reagent for a reaction process that intended to take place. Typically, this concentration is between about 5 wt % and 10 wt %.

The ammonium hydroxide is typically prepared by known means, such as by dissolving ammonia into water or by saturating water with ammonia in some other way.

In some examples this first step is provided before a method according to an aspect disclosed herein is started as preparation for the method to be carried out.

A second step, carried out subsequent to the first step, can be considered a main working stage of the apparatus 1. In this step the wash water is provided from the wash water supply 12 to the scrubber 10. This is achieved by the pump 15, under the control of the monitoring module 16, drawing wash water from the wash water supply, passing the wash water through the inlet pipe 122 and into the scrubber through the atomiser 126 (shown in FIG. 1).

When in the scrubber 10, SOx from the gas stream passing through the scrubber is absorbed by the wash water. This may be as a result of the SOx dissolving in the wash water. This forms an aqueous solution containing ammonium hydroxide and SOx.

The wash water is then drawn from the scrubber 10 through the collection pipe 124 back to the wash water supply 12. In the example shown in FIG. 3, this is achieved by use of the collection pump 18. This is typically also controlled by the monitoring module 16.

Once SOx have been absorbed by the wash water a chemical reaction is able to take place. This reaction is:

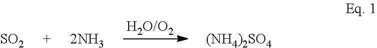

In this reaction, sulphur dioxide reacts with ammonia in the presence of water and oxygen to form ammonium sulphate.

The reaction set out in Eq. 1 takes place between the SOx being absorbed by the wash water in the scrubber 10 and the wash water supply 12, and may continue in the wash water supply. This includes the period the wash water is in the collection pipe 124.

Once the wash water is returned to the wash water supply 12, during the second step, the water is cycled back to the scrubber 10. However, the reaction set out in Eq. 1 is dependent on the temperature. As such, the temperature of the wash water is managed in some examples. This can be through active temperature control or passive temperature control.

In some examples, to assist with temperature control of the wash water, the wash water supply is equipped with a temperature control system that controls the temperature of the wash water. In various examples, this includes heat exchanger 13, which functions as set out above in relation to FIG. 1. This helps maximise the quantity of SOx that reacts to form ammonium sulphate before the wash water is cycled through the apparatus 1 again by passing to the pump 15 and through the inlet pipe 122.

Typically, the temperature control system applies cooling. This is because when the gas stream passing through the gas supply 11 and scrubber 10 is an exhaust stream from an engine, the temperature of the gas is around 200 degrees centigrade (° C.) to 230° C. The reaction set out in Eq. 1 proceeds at an optimum rate at around 60° C. or at lower temperatures. To achieve this, the wash water is, typically, provided to the scrubber 10 at about 20° C. or colder. This lowers the temperature in the scrubber to about 60° C. to 80° C. and leads to the gas stream leaving the scrubber at a temperature of about 40° C. to 50° C. When the wash water is returned to the wash water supply 12 from the scrubber, it is cooled back to about 20° C. so that the wash water is at this temperature again when it is cycled back to the scrubber.

The wash water itself cools the gas stream. Due to the relatively low concentration of ammonium ions in the wash water, the water in the wash water is over-subscribed so primarily contributes to cooling of the gas stream.

The monitoring module 16 monitors the wash water as it is cycled around the wash water supply 12 and scrubber 10. Over time, due to the cycling of the wash water, the amount of ammonium sulphate present in the wash water increases and the amount of reagent ammonium ions (i.e. ammonium hydroxide) decreases.

The third step in the process takes place when the monitoring module 16 detects that the wash water has reached an optimum composition. Typically, this is when a minimum threshold of ammonium hydroxide or reagent ammonium ions is reached. In some examples this is identified by monitoring the pH of the wash water.

When the wash water is provided to the wash water supply 12, the pH is about pH 14. When the minimum threshold of ammonium hydroxide is reached, due to the ammonium ions having reacted to form ammonium sulphate, the pH of the wash water is about pH 6. As such, when a predetermined pH is reached (set by the quantity of SOx that is intended to be removed), the process, in some examples, moves to the third step.

In the third step, the wash water in the wash water supply 12 is transferred to the storage tank 14 (shown in FIG. 1). The process then returns to the first step with the wash water supply being re-filled with wash water. The wash water that is in the storage tank contains the ammonium sulphate, which has value due to its fertiliser use. This is then stored until it is unloaded or is moved to another storage facility (not shown).

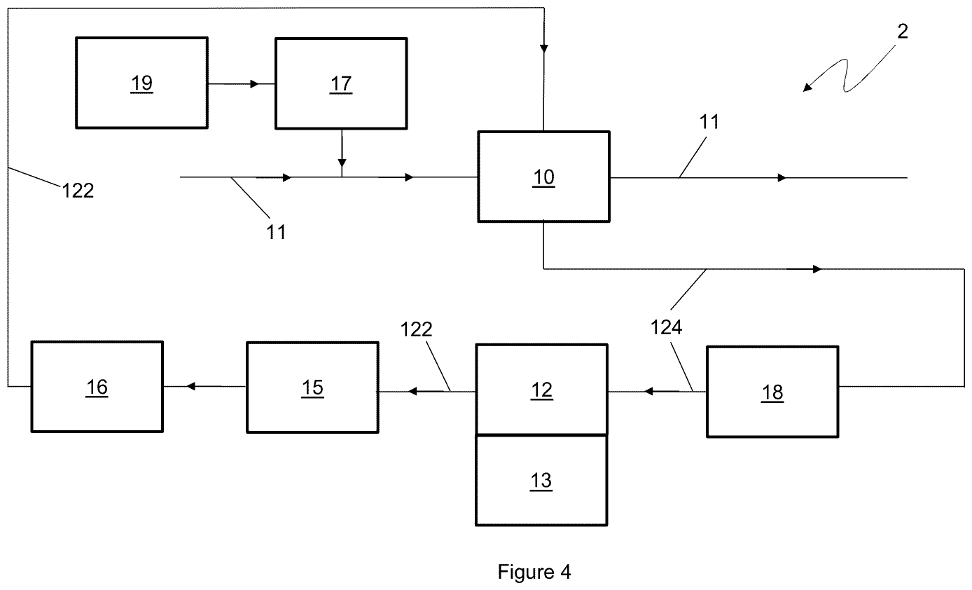

FIG. 4 shows an apparatus 2 according to the second example. Consistent with the first example apparatus 1 shown in FIGS. 1 and 3 and the second example shown in FIG. 2, this has features identical to the first example apparatus shown in FIGS. 1 and 3. As such, this a scrubber 10, gas supply 11, wash water supply 12, inlet pipe 122, collection pipe 124, atomiser 126, drain 127, heat exchanger 13, coolant inlet 131, coolant outlet 132, wash water inlet 133, wash water outlet 134, storage tank 14, pump 15, monitoring module 16 and pH sensor 162 as described above. The atomiser, coolant inlet, coolant outlet, wash water inlet, wash water outlet, storage tank and pH sensor are not shown in FIG. 4. A collection pump 18 is also present and is identical to the collection pump of the first apparatus.

The features common to the second example apparatus 2 and first example apparatus 1 are identical to each other, operate in the same way and have the same functions. As such, the second example apparatus is able to remove SOx in a gas stream passing along the gas supply 11 through the scrubber 10. As with the first example apparatus, this is achieved by reacting ammonium hydroxide in wash water with SOx absorbed by the wash water to form ammonium sulphate by the reaction set out in Eq. 1 above. Further, this means the example of FIG. 4 has the same wash water cycling, temperature control and three step process as the first example apparatus 1.

In addition, the example shown in FIG. 4 is able to remove NOx from the gas stream. This involves injection of ozone (O3, O₃) into the gas stream. The injection of the ozone converts NOx into dinitrogen pentoxide (N2O5, N₂O₅) by the following reactions:

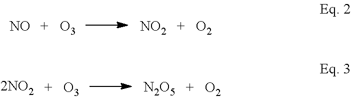

In an aqueous environment, the dinitrogen pentoxide forms nitric acid (HNO₃) by the following reaction route:

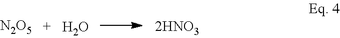

When ammonia is present the aqueous environment, the nitric acid reacts forming ammonium nitrate (NH4NO3, NH₄NO₃). This is in parallel to the SOx also reacting as set out in Eq. 1 above.

The nitric acid reaction is:

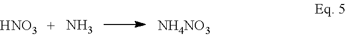

For the ammonium nitrate to form following the reaction sequence from Eq. 2 to Eq. 5, the apparatus 2 shown in FIG. 4 has an ozone injector 17 connected to and able to supply ozone to the gas supply 11. This is connected upstream of the scrubber 10 in the example shown in FIG. 4. In use, the ozone mixes with the gas stream in the gas supply 11.

In some examples, the ozone injector 17 is connected to an ozone generator 19. This may be a local source of ozone, such as an ozone container. Alternatively, the ozone may be provided from a source outside of the apparatus 2.

As mentioned above, the example apparatus 2 show in FIG. 4 is capable of conducting the same three-step process as the example apparatus 1 shown in FIG. 3. This means the aqueous ammonia solution, in the form of ammonium hydroxide is provided to the wash water supply 12, this is cycled through the scrubber 10 absorbing SOx, NOx and ozone. The reactions as set out in Eq. 1 to Eq. 5 are then able to proceed, with the conditions being enhanced for at least Eq. 1 by temperature control of the wash water using the heat exchanger 13.

The concentration of ammonium hydroxide in the wash water is again set to provide an appropriate amount of ammonia/ammonium ions for the desired quantity of SOx and NOx to be removed from the gas stream. The quantity of ozone supplied is also set to allow the desired quantity of NOx to be removed from the gas stream.

When the monitoring module 16 identifies that the appropriate conditions are met the wash water is transferred to the storage tank 14 (shown in FIG. 2). In the example shown in FIG. 4, the contents of the wash water that are of value are ammonium sulphate and ammonium nitrate.

The conditions the monitoring module identifies for the wash water to be transferred are typically the pH measured by the pH sensor 162 identifying the wash water pH has lowered from about pH 14 to about pH 6. The three-step process is then able to be repeated as desired once the transfer has occurred.

As with the example shown in FIG. 3, the gas stream exits the scrubber 10 by gas supply 11. The gas that exits the scrubber is gas that has been treated. In the example shown in FIG. 3, this is gas with a lower quantity of SOx, and in the example shown in FIG. 4, this is gas with a lower quantity of SOx and NOx.

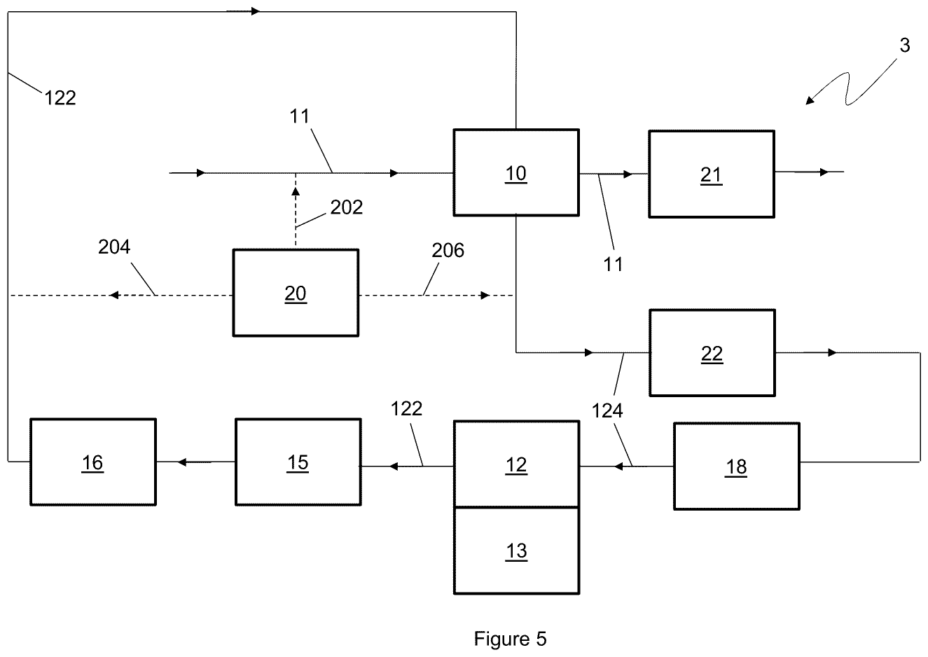

FIG. 5 shows a third example apparatus 3. In addition to other features, this has features identical to the first example apparatus 1 shown in FIGS. 1 and 3.

As such, this has a scrubber 10, gas supply 11, wash water supply 12, inlet pipe 122, collection pipe 124, atomiser 126, drain 127, heat exchanger 13, coolant inlet 131, coolant outlet 132, wash water inlet 133, wash water outlet 134, storage tank 14, pump 15, monitoring module 16 and pH sensor 162 as described above. The atomiser, coolant inlet, coolant outlet, wash water inlet, wash water outlet, storage tank and pH sensor are not shown in FIG. 5. A collection pump 18 is also present and is identical to the collection pump of the first apparatus and second apparatus 2.

The features common to the third example apparatus 3 and first example apparatus 1 are identical to each other, operate in the same way and have the same functions. The third example apparatus also provides an ability to control the amount of chemical reagent in the wash water (i.e. in the scrubbing medium).

As such, the third example apparatus is able to remove SOx in a gas stream by reacting ammonium hydroxide in wash water with SOx absorbed by the wash water to form ammonium sulphate by the reaction set out in Eq. 1 above.

The example apparatus 3 show in FIG. 5 achieves the formation of ammonium sulphate by conducting the same three-step process as the example apparatus 1 shown in FIG. 3. This means the aqueous ammonia solution, in the form of ammonium hydroxide is provided to the wash water supply 12, this is cycled through the scrubber 10 absorbing SOx. The reactions as set out in Eq. 1 is then able to proceed, with the conditions being enhanced for Eq. 1 by temperature control of the wash water using the heat exchanger 13.

The concentration of ammonium hydroxide in the wash water is set to provide an appropriate amount of ammonia/ammonium ions for the desired quantity of SOx to be removed from the gas stream.

When the monitoring module 16 identifies that the appropriate conditions are met the wash water is transferred to the storage tank 14 (shown in FIG. 2). In the example shown in FIG. 4, the contents of the wash water that are of value are ammonium sulphate and ammonium nitrate.

The conditions that the monitoring module identifies for the wash water to be transferred are typically the pH measured by the pH sensor 162 identifying the wash water pH has lowered from about pH 14 to about pH 6. The three-step process is then able to be repeated as desired once the transfer has occurred.

As with the example shown in FIG. 3, the gas stream exits the scrubber 10 by gas supply 11. The gas that exits the scrubber is gas that has been treated. In the example shown in FIG. 5, this is gas with a lower quantity of SOx.

In the example apparatus 3 shown in FIG. 5, it is possible to increase a quantity of reagent in different locations. This can be of value because, from time to time, the scrubbing medium, so the wash water, may not contain enough reagent to fulfil the scrubbing process.

To be able to increase the reagent, the apparatus 3 shown in the example of FIG. 5 has a reagent injector 20. This is an ammonia injector in various examples. In some examples this is capable of supplying ammonia, such as in gas form, from an ammonia source, which may be local or remote.

The reagent injector 20 is optionally operatively connected to one, two (in any combination) or each (i.e. all) of the gas supply 11, the inlet pipe 122 and the collection pipe 124. Each operative connection allows reagent to be injected into the respective gas stream or wash water flow.

The reagent injector 20 is used when wash water is being cycled between the scrubber 10 and the wash water supply 12 via the inlet pipe 122 and collection pipe 124 to scrub gas in a gas stream passing through the gas supply 11.

The reagent injector 20 is connected to the gas supply 11 by a gas supply connection 202. In various examples this permits ammonia to be provided into the gas stream that then passes into the scrubber 10. When provided, this connection is used when there is SOx remaining in the wash water that has been drained from the scrubber and/or gas stream downstream of the scrubber. This is because, if SOx are present in one or both of these locations the SOx have not reacted to form ammonium sulphate. As such, ammonia is provided, either at a predetermined volume or flow rate or at a tailored volume or flow rate to increase the amount of reagent present in the scrubber, to increase the quantity of SOx removed from the gas stream. This ammonia mixes with the gas stream and is absorbed, in the scrubber, by wash water being provided to the scrubber.

To allow for detection of SOx in the gas stream downstream of the scrubber 10, the example apparatus 3 shown in FIG. 5 has an emissions control device 21. This is typically provided by a known emissions control device. This is capable of monitoring various properties and/or composition of the gas stream.

In use the emissions control device 21 is able to be connected to a controller, of which the monitoring module 16 may be a part, or which may be provided by the monitoring module. In alternative examples such a controller is independent from the monitoring module. Regardless of this, and whether the controller is present, in some examples, the monitoring carried out by the emissions control device is able to provide feedback of a quantity of SOx in the gas stream in the gas supply 11 downstream of the scrubber 10. This feedback is able to be used to adjust the amount of ammonia provided by the reagent injector 20 through any one of its connections to take account of a quantity of SOx present.

Further, in some examples, the apparatus 3 shown in FIG. 5 has a control device 22. This is connected to the collection pipe 124 or to another suitable location on a flow path followed by the wash water while being cycled around the apparatus.

In various examples, the control device 22 is able to detect (unreacted) SOx in the wash water. Similarly to the emissions control device 21, the control device is able to be connected to a controller, of which the monitoring module 16 may be a part, or which may be provided by the monitoring module. In alternative examples such a controller is independent from the monitoring module. Regardless of this, and whether such a controller is present, in some examples, the monitoring carried out by the control device is able to provide feedback of a quantity of SOx in the wash water passing through the collection pipe. This feedback is able to be used to adjust the amount of ammonia provided by the reagent injector 20 through any one of its connections to take account of a quantity of SOx present.

In the example shown in FIG. 5, the reagent injector 20 is also connected to the inlet pipe 122 by an inlet pipe connector 204. In various examples this permits ammonia to be provided into the wash water before the wash water passes into the scrubber 10. When provided by this mechanism, the ammonia dissolves in the wash water in the inlet pipe. This increases ammonium ions concentration in the wash water. In use, this addition of ammonia to the wash water would typically be conducted if the amount of reagent in the wash water is lower than desired at a point during the cycling process. This would then provide an increased ability for SOx absorbed by the wash water in the scrubber to react to form ammonium sulphate, which would boost the quantity of SOx that could be removed from the gas stream.

The reagent injector 20 in the example apparatus 3 of FIG. 5 is further connected to the collection pipe 124 by a collection pipe connector 206. In various examples this permits ammonia to be provided into the wash water after the wash water is drained from the scrubber 10. When provided by this mechanism, the ammonia dissolves in the wash water. This again increases the ammonium ions concentration in the wash water. This would then be capable of reacting with SOx present in the wash water drained from the scrubber.

Addition of ammonia by the collection pipe connector 206 would typically be carried out when the SOx is identified (above a threshold quantity) by emissions control device 21 and/or the control device 22. The amount of ammonia provided through this connector is able to be tailored in the same way and for the same reasons as set out above in relation to the gas supply connector 202.

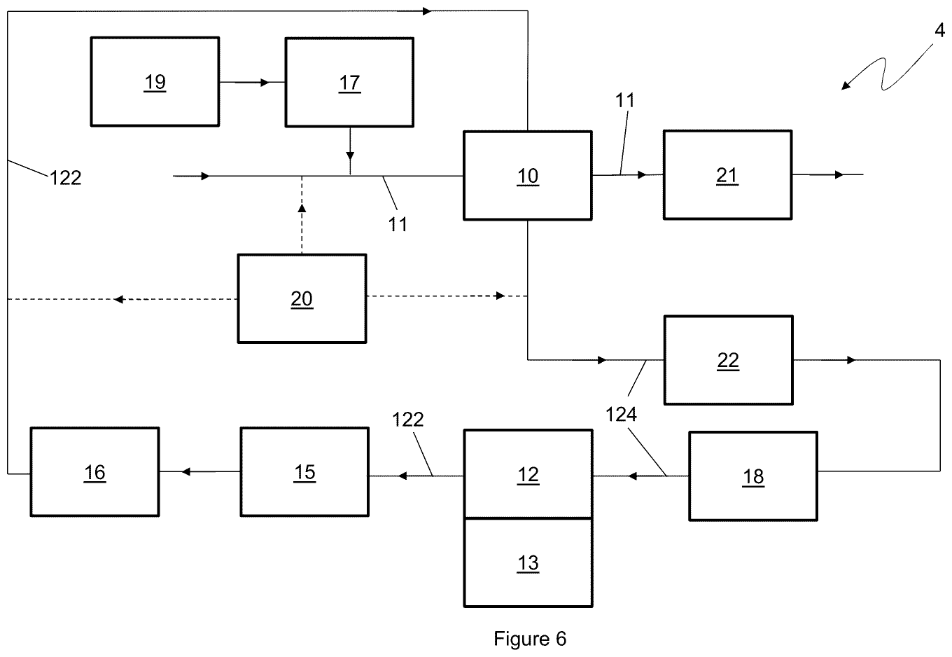

Turning to FIG. 6, this shows a fourth example apparatus 4. This apparatus is capable of removing SOx and NOx from a gas stream. This is achieved by providing an apparatus equivalent to a combination of the second apparatus 2 and the third apparatus 3. As such, the fourth example apparatus includes a scrubber 10, gas supply 11, wash water supply 12, inlet pipe 122, collection pipe 124, atomiser 126, drain 127, heat exchanger 13, coolant inlet 131, coolant outlet 132, wash water inlet 133, wash water outlet 134, storage tank 14, pump 15, monitoring module 16 and pH sensor 162, ozone injection system 17, ozone generator 19, reagent injector 20, gas supply connector 202, inlet pipe connector 204, collection pipe connector 206, emissions control device 21 and control device 22 as described above. The atomiser, coolant inlet, coolant outlet, wash water inlet, wash water outlet, storage tank and pH sensor are not shown in FIG. 5. A collection pump 18 is also present and is identical to the collection pump of the first apparatus 1, second apparatus and third apparatus 3.

The features of the fourth example apparatus 4 that are common with features of to the second example apparatus and those common with features of the third example apparatus 3 and first example apparatus 1 are identical to each other, operate in the same way and have the same functions. As such, the fourth example apparatus provides an ability to control the amount of chemical reagent in the wash water (i.e. in the scrubbing medium); is able to remove SOx in a gas stream by reacting ammonium hydroxide in wash water with SOx absorbed by the wash water to form ammonium sulphate by the reaction set out in Eq. 1 above; and is able to remove NOx in a gas stream by reacting, via Eq. 2 to Eq. 5 above, NOx with ozone and reacting ammonium hydroxide in wash water with nitric acid formed from the NOx and ozone reaction to form ammonium nitrate.

As mentioned above, the example apparatus 4 show in FIG. 5 is capable of conducting the same three-step process as the example apparatus 2 shown in FIG. 4. This means the aqueous ammonia solution, in the form of ammonium hydroxide is provided to the wash water supply 12, this is cycled through the scrubber 10 absorbing SOx, NOx and ozone. The reactions as set out in Eq. 1 to Eq. 5 are then able to proceed, with the conditions being enhanced for at least Eq. 1 by temperature control of the wash water using the heat exchanger 13.

The concentration of ammonium hydroxide in the wash water is again set to provide an appropriate amount of ammonia/ammonium ions for the desired quantity of SOx and NOx to be removed from the gas stream. The quantity of ozone supplied is also set to allow the desired quantity of NOx to be removed from the gas stream.

When the monitoring module 16 identifies that the appropriate conditions are met the wash water is transferred to the storage tank 14 (shown in FIG. 2). In the example shown in FIG. 4, the contents of the wash water that are of value are ammonium sulphate and ammonium nitrate.

The conditions the monitoring module identifies for the wash water to be transferred are typically the pH measured by the pH sensor 162 identifying the wash water pH has lowered from about pH 14 to about pH 6. The three-step process is then able to be repeated as desired once the transfer has occurred.

As with the example shown in FIG. 4, the gas stream exits the scrubber 10 by gas supply 11. The gas that exits the scrubber is gas that has been treated. In the example shown in FIG. 6, this is gas with a lower quantity of SOx and NOx.

In addition to the reagent injector 20 providing ammonia to react with unreacted SOx, the reagent injector is able to provide ammonia to react with unreacted nitric acid. As such, the emission control device 21 and/or the control device 22 are capable in some examples of detecting, downstream of the scrubber 10, the presence of NOx and/or nitric acid in the gas stream or wash water respectively. Further, the reagent injector is able to provide ammonia in relation to conversion of NOx to ammonium nitrate based on feedback and for the same reasons as set out above in relation to SOx conversion to ammonium sulphate in relation to the use of the reagent injector of the third example apparatus 3 shown in FIG. 5.

The gas supply connector 202 is shown connected to the gas supply 11 upstream of the ozone injector 17 in the example shown in FIG. 6. In other examples, this positioning is able to be reversed or the gas supply connector and ozone injector are able to be connected to the gas supply at the same location.

Irrespective of which of the first to fourth example apparatus is provided, or whether an apparatus with different features is provided instead, in accordance with an aspect disclosed herein, there is use of ammonia in wash water of a (closed-loop) wet scrubber. In some examples this use of ammonia is to react with SOx and/or NOx (in the presence of ozone) in gas passing through the wet scrubber to produce ammonium sulphate and/or ammonium nitrate respectively.

1. An apparatus for removing pollutants from a gas, comprising:
a scrubber connected to a gas supply such that the gas passes into the scrubber;
a wash water supply providing wash water to the scrubber, the wash water containing ammonium ions; and
a collector receiving wash water from the scrubber provided by the wash water supply.

2. The apparatus according to claim 1, wherein the collector is connected to the wash water supply and provides the received wash water to the wash water supply thereby circulating the wash water in use.

3. The apparatus according to claim 2, wherein the wash water is cooled between receiving the wash water from the scrubber and providing the wash water to the scrubber.

4. The apparatus according to claim 3, further comprising a heat exchanger connected to a cooling source, the heat exchanger cooling the received wash water by transferring heat to the cooling source and providing the cooled wash water to the wash water supply.

5. The apparatus according to claim 2, further comprising a monitoring module configured to analyze the wash water received by the collector and to control the circulation of the wash water based on the analysis.

6. The apparatus according to claim 5, wherein the monitoring module includes a pH sensor configured to measure the pH of the wash water received by the collector, the circulation of the wash water being based on the measured pH of the received wash water.

7. The apparatus according to claim 1, wherein the ammonium ions in the wash water has a concentration up to 10 percent by weight (wt %).

8. The apparatus according to claim 1, further comprising a storage tank, wash water being transferable from the collector to the storage tank, the storage tank being configured to hold wash water received by the collector.

9. The apparatus according to claim 1, wherein the amount of ammonium ions in the wash water system is increasable.

10. The apparatus according to claim 1, further comprising an ammonia input in the wash water system, and/or in the gas supply and/or scrubber, and/or in the collector.

11. The apparatus according to claim 1, further comprising an ozone input in the gas supply and/or scrubber.

12. A closed-loop wet scrubber including a cyclical wash water system with wash water including, in use, ammonium ions; and a storage tank in which used wash water is able to be held after cycling through the wash water system.

13. A method of removing pollutants from a gas, comprising:
providing, to a scrubber connected to a gas supply, wash water containing ammonium ions to scrub gas from the gas supply with the wash water; and
receiving, in a collector, the wash water from the scrubber after providing the wash water to the scrubber.

14.-18. (canceled)
